(19) United States
(12) Patent Application Publication
(10) Pub. No.: US 2022/0222606 A1
(43) Pub. Date: Jul. 14, 2022

(54) COLLABORATIVE WORKING SPACE IN AN XR ENVIRONMENT

(71) Applicant: Taqtile, Inc., Seattle, WA (US)

(72) Inventors: John TOMIZUKA, Seattle, WA (US); Dirck T. SCHOU, JR., Bainbridge Island, WA (US)

(21) Appl. No.: 17/149,290

(22) Filed: Jan. 14, 2021

(51) Int. Cl. G06Q 10/06; H04L 9/00; G06F 16/27; G06F 16/23; G06T 11/00

(52) U.S. Cl. CPC G06Q 10/063114; G06Q 10/06316; G06T 11/00; G06F 16/27; G06F 16/2379; H04L 9/006

(57) ABSTRACT

Implementing a collaborative working space in an XR environment includes executing an XR collaboration application to provide a virtual reality experience within an XR environment representing a real-world environment on a user device. Within the XR environment, an XR author may create a task associated with virtual content as the virtual content is viewed by the XR author on the user device. The XR author may assign the task to a collaborator operating in the XR environment based at least on one or more criteria.

### BACKGROUND

Presently, consumers may experience several different modes of virtual experiences via appropriately enabled user devices. In one example, the user experience may derive solely from computer-generated content executed via a virtual reality (VR) enabled device, which can provide a fully computer-generated visual experience that appears to surround the user. In another example, the user experience may derive from virtual content that overlays real-world content via an augmented reality (AR) device. In other words, the user experience may be comprised of a real-world experience that is augmented to include at least some computer-generated content. In yet another example, the user experience may derive from a combination of VR and AR, generated denoted as mixed reality (MR). While the term MR is intended to be more inclusive, it still excludes pure VR experiences. To cover all modes, the term extended reality (XR) may be used.

Applications such as an authoring tool may be used to define virtual content and related actions that allow for the creation and modification of workflow applications with multiple virtual environments. The authoring tool may receive and render for presentation, or other uses, the virtual content, via user devices. However, creating and modifying virtual content in virtual environments may require a collaborative working space that allows the allocation of tasks to be performed. Accordingly, a number of devices including varying configurations may be implemented for the collaborative working space, and interfacing with each potential user device operating in an XR environment may be challenging.

### BRIEF DESCRIPTION OF THE DRAWINGS

The detailed description is described with reference to the accompanying figures, in which the leftmost digit(s) of a reference number identifies the figure in which the reference number first appears. The use of the same reference numbers in different figures indicates similar or identical items.

FIG. 1 illustrates an example of a network architecture for implementing a collaborative working space in an XR environment for a plurality of collaborators.

FIG. 2 is a flow diagram of showing transactions being recorded in a blockchain.

FIG. 3 is a block diagram showing various components of an illustrative computing device that implements a collaborative working space in an XR environment.

FIG. 4 is a flow diagram of an example process for providing an ad hoc or planned collaborative working space in an XR environment for multiple collaborators.

FIG. 5 is a flow diagram of an example process for verifying completion of a task.

FIG. 6 is a flow diagram of an example process for selecting a collaborator to assign tasks.

### DETAILED DESCRIPTION

This disclosure is directed to techniques for handing off tasks to one or more users via an XR collaboration application. In one aspect, the XR collaboration application may be configured to provide an XR environment via a head-mounted device (HMD), a handheld device, and/or other types of XR capable user devices. The XR environment may represent a real-world environment and may include one or more objects. The XR collaboration application may receive a user command from an XR author to interact with the one or more objects. The objects can be real objects or virtual objects that may represent real objects in the real-world environment. In some aspects, the XR author may create and/or perform a task within the XR environment via the XR collaboration application. For example, a task may include creating, editing, modifying, and/or developing virtual content. In another example, a task may include associating virtual content with the one or more objects in the XR environment. The task may include multiple steps that may be delegated to other users (i.e., collaborators) operating in the XR environment. Additionally, or alternatively, completing one task may create follow up tasks that may be delegated to other users.

The individual collaborators may be associated with a user account of the XR collaboration application. The user account may be associated with a user profile that includes one or more credentials or tags indicating skill sets or qualifications associated with the collaborator. In some aspects, the tags may be location-based or equipment/device-based. The user profile may also indicate an expertise level and/or an area of expertise that can be associated with a tag.

In some aspects, the XR author may create a task, via a first user device, and hand off the task to a collaborator that is operating in the XR environment in an ad-hoc manner and/or on a scheduled basis. In the latter case, the XR collaboration application may be configured to receive a schedule configuration from the XR author. The collaborator may be selected from a list of available collaborators operating in the same XR environment and/or from a list of contacts associated with the XR author. The selected collaborator may receive, at a second user device, the assigned task.

A task may be placed on a queue and then transmitted to a selected collaborator according to the schedule configuration. Additionally, or alternatively, a task may be assigned to the first available collaborator or assigned via round-robin or other task routing schemes. In some aspects, a plurality of collaborators may participate in an auction to place a bid to complete a task. A collaborator may be selected from the plurality of collaborators based at least on the submitted bid.

Accordingly, the techniques herein may streamline the process for collaborating within an XR environment. The techniques described herein may be implemented in a number of ways. Example implementations are provided below with reference to the following figures.

### Example Network Architecture

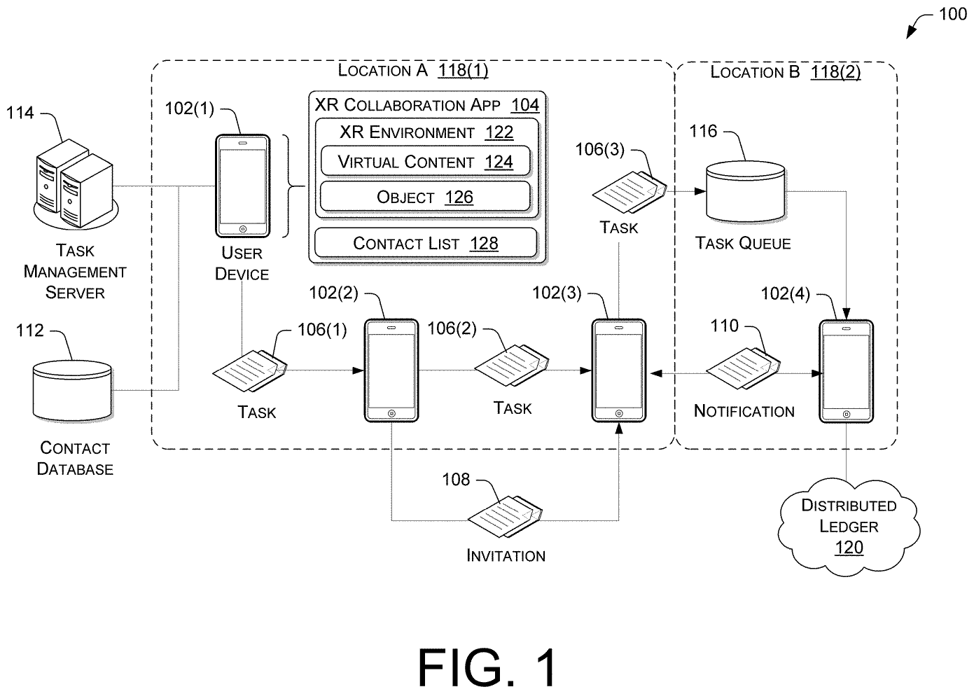

FIG. 1 illustrates an example of a network architecture for implementing a collaborative working space in an XR environment for a plurality of collaborators. The network 100 includes one or more user devices 102(1)-102(4) that may be in communication with a task management server 114 that is configured to track and manage one or more tasks to be performed in an XR environment. The user devices 102(1)-102(4) can include various VR, AR, and MR user equipment, such as a head-mounted device (HMD) or a headset. The user devices 102(1)-102(4) may also include smartphones, mobile devices, personal digital assistants (PDAs), or other electronic devices having a wireless communication function, that are capable of receiving input, processing the input, and generating output data to facilitate an augmented reality platform and/or a virtual reality platform. The user devices 102(1)-102(4) are connected to a telecommunication network utilizing one or more wireless base stations or any other common wireless or wireline network access technologies.

The user devices 102(1)-102(4) is configured to communicate with the network 100. The network 100 can be a cellular network that implements 2G, 3G, 4G, and long-term evolution (LTE), LTE advanced, high-speed data packet access (HSDPA), evolved high-speed packet access (HSPA+), universal mobile telecommunication system (UMTS), code-division multiple access (CDMA), global system for mobile communications (GSM), a local area network (LAN), a wide area network (WAN), and/or a collection of networks (e.g., the Internet).

The XR collaboration application 104 may be implemented on user devices 102(1)-102(4) associated with an XR author. The XR collaboration application 104 may be executable via one or more hardware, software, or communication environments, each of which enables the presentation of an XR environment 122 and development of virtual content 124 within the XR environment 122. The virtual content 124 can include graphical content such as images, including charts, graphs, icons, symbols, and/or so forth. The virtual content 124 can also include textual content and/or multimedia content such as audio, animation, and video. The XR environment 122 may represent a real-world environment. The XR environment 122 may include one or more objects 128 with which users can interact. The one or more objects 128 can be real objects or virtual objects that represent real objects in a real-world environment represented in the XR environment 122. The objects 128 may be associated with one or more virtual content 124. The XR collaboration application 104 may be configured to receive a user command from an XR author or other users to interact with the one or more objects 128 within the XR environment 122. In one example, a user command can include speech inputs, gesture inputs, eye tracking inputs, motion inputs, and/or any other suitable input type.

The XR collaboration application 104 and related techniques as described herein may also be used in a number of platform contexts for viewing, editing, creating, and manipulating virtual content 124. In one example, the XR collaboration application 104 may implement an authoring component such as an authoring tool. The user devices 102(1)-102(4) may be configured with an XR application interface that may provide an XR author with a user interface (UI) capable of utilizing the authoring tool to facilitate the creation and modification of virtual content 124 within the XR environment 122.

In some aspects, the authoring tool may enable multiple XR authors or users to collaborate to create and modify virtual content 124 within the XR environment 122. The XR collaboration application 104 may implement a task management tool to assign tasks to individual collaborators. For example, a task may include instructions to view, edit, create, and/or manipulate virtual content 124. The task may include multiple steps that may be delegated to other collaborators operating in the XR environment. Additionally, or alternatively, completing one task may allow one or more collaborators to create follow up tasks that may be delegated to other collaborators.

The individual collaborators may be associated with a user account of the XR collaboration application 104. The user account may be associated with a user profile that may indicate a collaborator's experiences, areas of expertise, level of proficiency in software or other areas, knowledge, skill sets, endorsements, and/or so forth. The user profile may also include one or more credentials or may be associated with tags indicating skill sets or qualifications associated with the collaborator. In some aspects, the tags may be location-based or equipment/device-based. For example, a user profile may be tagged with a location corresponding to a location of a factory, a plant, or a warehouse that may be represented in an XR environment. A collaborator that is associated with the user profile may then be selected to perform a task that requires interaction with an object in such XR environment. In another example, an additional user profile may be tagged with the names of equipment pieces corresponding to a machine that may be represented as a virtual object in an XR environment. An additional collaborator that is associated with the additional user profile may then be selected to perform a task that requires interaction with such virtual object in the XR environment.

Further, the tags may be team-based. For example, a user profile may be tagged with a team identifier that is associated with a business unit, group, or a team that is working on a project. The project may include one or more tasks to be performed within an XR environment. Accordingly, a tag may identify a collaborator that is associated with the user profile as a member of a team. The collaborator may be selected to perform a task that is associated with the team's project. The tags may also be project-based or further specified to indicate a collaborator's eligibility to perform a task. For instance, a first user profile may be tagged with a team identifier that is associated with a team and a project identifier that is associated with the team's project. A second user profile may be tagged with the same team identifier and an additional project identifier that is associated with a different project. Accordingly, two user profiles associated with different collaborators on the same team may be tagged with the same team identifier but different projects. A collaborator that is associated with the first user profile may be selected to perform a task that is associated with the team's project.

In some aspects, multiple user profiles may be associated with the same tags. For instance, similar to the example above, two user profiles associated with different collaborators on the same team may be tagged with the same team identifier and the same project identifier. In such scenarios, an XR author may create a task and select one of the collaborators and designate the other collaborator as an alternate. Additionally, or alternatively, a task may be automatically routed via a task routing scheme (e.g., round-robin) or based at least on the availability and workload of the collaborators. In some aspects, the XR collaboration application 104 may provide an auction-based platform for requesting and receiving bids to perform tasks from one or more collaborators. Upon receiving bids from the one or more collaborators, an XR author may select a collaborator based at least on the winning bid.

In some aspects, an XR author may create a task 106(1) via a first user device 102(1) and hand off the task 106(1) to an ad hoc collaborator operating in the XR environment 122 via a second user device 102(2). The collaborator may be selected from a list of available collaborators operating in the same XR environment 122, wherein the list can comprise an address book or a list of contacts associated with the XR author. The list of contacts may be stored locally in the user device 102(1) and/or in the contact database 122.

In some aspects, the XR author may hand off the task 106(1) to a collaborator according to a schedule configuration. In this example, the XR author may create a task 106(1) and then select a collaborator from the XR author's list of contacts to perform the task 106(1). The XR author may schedule the task 106(1) to be released to the selected collaborator at the second user device 102(2) at a designated date and time via the XR collaboration application 104. In some aspects, the task 106(1) may then be added to a task queue 116 and held at the task queue 116 until the designated date and time before the task 106(1) is released to the selected collaborator at the second user device 102(2). Subsequently, the collaborator, via the second user device 102(2), can accept the assignment of the task and perform the task 106(1).

In some aspects, the XR author can plan hand-offs of tasks among multiple collaborators. In this example, the XR author may create a first task 106(1) and a second task 106(2), via the first user device 102(1), and select one or more collaborators from the XR author's list of contacts to complete the tasks 106(1) and 106(2). For example, the XR author may select a collaborator to perform the first task 106(1) via the second user device 102(2), and an additional collaborator to perform the second task 106(2) via the third user device 102(3).

In some aspects, the collaborator may complete the task 106(1) via the second user device 102(2). Upon completing the task 106(1), the collaborator may create a second task 106(2) or receive the second task 106(2) from the XR author. The collaborator may perform the second task 106(2) or assign the second task 106(2) to an additional collaborator. In the latter example, the collaborator may select an additional collaborator from the collaborator's list of contacts and transmit an invitation 108 to the additional collaborator at the third user device 102(3) to complete the second task 106(2). The invitation 108 may include a request and a set of instructions to complete the second task 106(2). Upon receiving the invitation 108, the additional collaborator at the third user device 102(3) may accept the collaborator's request to perform the task 106(2).

In some aspects, the XR author, via the first user device 102(1), may transmit invitations to perform the first task 106(1) and the second task 106(2) to the collaborator and the additional collaborator, respectively. The tasks 106(1) and 106(2) may be held at the task queue 116 until both the collaborator and the additional collaborator accept the respective invitations. Additionally, or alternatively, the XR author may transmit an invitation to the collaborator before transmitting an invitation to the additional collaborator when the first task 106(1) is to be performed before the second task 106(2).

In some aspects, the additional collaborator, via the third user device 102(3), may reject the invitation 108 and delegate the task 106(2) to an alternate collaborator that is operating the fourth user device 102(4). In this regard, the additional collaborator at the third user device 102(3) may pass the invitation 108 to the alternate collaborator at the fourth user device 10(4). The alternate collaborator may be selected from the additional collaborator's contact list. Additionally, or alternatively, the additional collaborator at the third user device 102(3) may place the task 106(2) in the task queue 116 in response to rejecting the invitation 108. The task queue 116 may in turn assign the task 106(2) to the alternate collaborator at the fourth user device 102(4) according to a task routing scheme. In some examples, the task routing scheme may include a round-robin scheme and/or a priority scheme based at least on the availability of collaborators.

In some aspects, the additional collaborator, via the third user device 102(3), may complete the second task 106(2) and create a third task 106(3). The third task 106(3) may be transmitted to the task queue 116. Additionally, or alternatively, the additional collaborator at the third user device 102(3) may select an alternate collaborator at the fourth user device 102(4) to perform the task 106(3). The alternate collaborator, via the fourth user device 102(4), may perform the task 106(3) and send a notification 110 to the additional collaborator at the third user device 102(3) indicating that the task 106(3) is completed.

In response to receiving the notification 110 of the task completion, the additional collaborator, via the third user device 102(3), may verify that the task 106(3) is completed by reviewing the task performances. Upon determining that the task 106(3) is completed, the additional collaborator, via the third user device 102(3), may send a notification 110 to the alternate collaborator at the fourth user device 102(4) indicating that the task completion has been verified. Conversely, the additional collaborator, via the third user device 102(3), may identify deficiencies with the task performances and determine that the task 106(3) is not completed. Upon determining that the task completion cannot be verified, the additional collaborator, via the third user device 102(3), may send a notification 110 to the alternate collaborator at the fourth user device 102(4) identifying deficiencies and a request to repeat performance. The additional collaborator may be a subject matter expert with credentials to verify that the task 106(3) is completed. Additionally, or alternatively, the additional collaborator may, in response to receiving the notification 110 of the task completion, transmit a request, via the third user device 102(3), to a designated expert collaborator or a third-party expert to verify that the task 106(3) is completed.

In some aspects, the XR collaboration application 104 may reside on a remote server, identified as the task management server 114. The task management server 114 may include general-purpose computers, such as desktop computers, tablet computers, laptop computers, servers (e.g., on-premise servers), or other electronic devices that are capable of receiving input, processing the input, and generating output data. The task management server 114 can include a plurality of physical machines that may be grouped and presented as a single computing system. Each physical machine of the plurality of physical machines may comprise a node in a cluster. Additionally, or alternatively, the task management server 114 may be in the form of virtual machines, such as virtual engines (VE) and virtual private servers (VPS).

The task management server 114 may store data in a distributed storage system, in which data may be stored for long periods and replicated to guarantee reliability. For example, the task management server 114 may access the distributed storage system such as data repositories that correspond to a third-party data store where virtual contents and other XR assets are stored. In FIG. 1, the distributed storage system may also include the contact database 112. The various data store in the distributed storage system can comprise a data management layer that includes software utilities for facilitating the acquisition, processing, storing, reporting, and analysis of data. In various embodiments, the data store can be configured with an application program interface (API) that can be called by an application or interface with an API of the application for providing data access.

The task management server 114 may be a component of an XR collaboration system. Generally, the task management server 114 may be configured to execute the XR collaboration application 104 based on inputs received from the user devices 102(1)-102(4) that are communicatively coupled via the network 100. In this example, the user devices 102(1)-102(4) may capture inputs from an XR author and further communicate the inputs to the XR collaboration system.

Additionally, the task management server 114 may manage tasks and task performances and verifications. For example, the task management server 114 may receive tasks from 106(1)-106(3) from the user devices 102(1)-102(4) and route the tasks 106(1)-106(3) to designated collaborators. The task management server 114 may also place the tasks 106(1)-106(3) in the task queue 116. In some aspects, the task management server 114 may report a task status to the creator of the task. For example, a task status may indicate whether a task is created, cancelled, assigned, delegated, in-queue, in-progress, completed, verified, and/or so forth. The task status may be presented via a graphical user interface of the XR collaboration application 104.

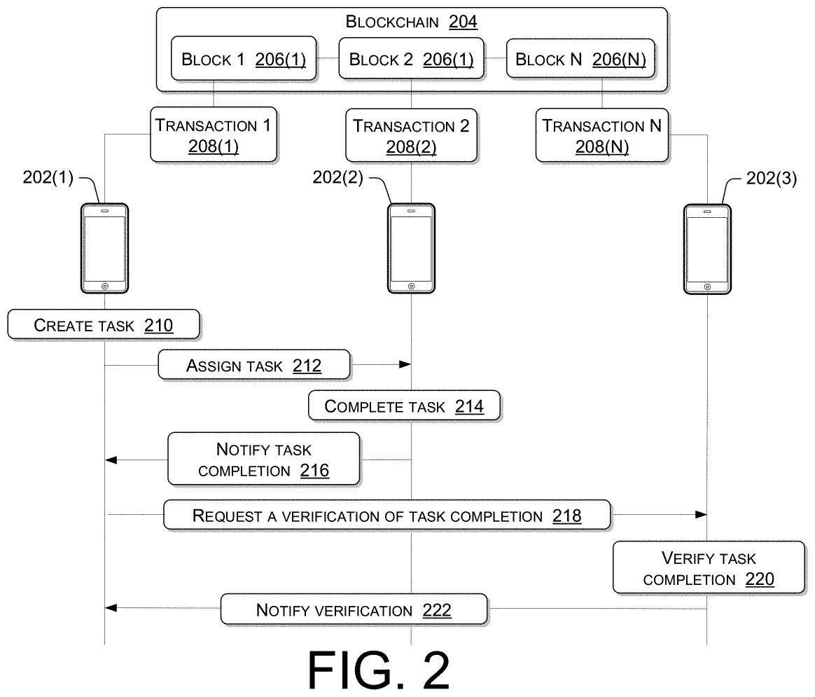

In some aspects, the individual transactions among the collaborators may be referenced in a distributed ledger 120. The distributed ledger 120 can comprise a blockchain that includes one or more blocks, wherein the individual blocks are associated with a transaction as further discussed with respect to FIG. 2. In FIG. 2, the blockchain 204 may include a plurality of blocks 206(1)-206(N). At block 210, an XR author, via the first user device 202(1) may create a task. The task may be performed in an XR environment that is presented via an XR collaboration application that resides in the first user device 202(1). The creation of a task may be recorded as a first transaction 208(1) in a first block 206(1) in the blockchain 204. In various embodiments, the blockchain 204 may implement multifactor authentication (MFA), public key infrastructure (PKI)-based authentication protocol, and/or other authentication methods.

At block 212, the XR author, via the first user device 202(1), may assign the task to a collaborator. The collaborator may operate in the XR environment via the second user device 202(2) that executes the XR collaboration application. At block 214, the collaborator may accept the assignment and complete the task via the second user device 202(2). The performance of the task may be recorded as a second transaction 208(2) in a second block 206(2) in the blockchain 204. At block 216, the collaborator may, via the second user device 202(2), notify of task completion to the XR author operating the first user device 202(1). The notification may indicate a record of all work performed (e.g., individual steps) to complete the task. For example, the notification may include time and date stamps corresponding to the time and date that the individual steps are performed and completed.

At block 218, the XR author, via the first user device 202(1) may transmit a request to the third user device 202(3) to verify the task completion. The third user device 202(3) may be operated by an expert collaborator with credentials to verify the task completion. At block 220, the expert collaborator, via the third user device 202(3), verifies the task completion. The verification of the task may be recorded as a third transaction 208(N) in a third block 206(N) in the blockchain 204. At block 222, the third user device 202(3) provides a notification indicating verification of the task completion to the first user device 202(1). While FIG. 2 shows three transactions 208(1)-208(N) being recorded in the blockchain 204, the blockchain 204 may reference fewer or more transactions associated with tasks, depending upon embodiments.

### Example Computing Device Components

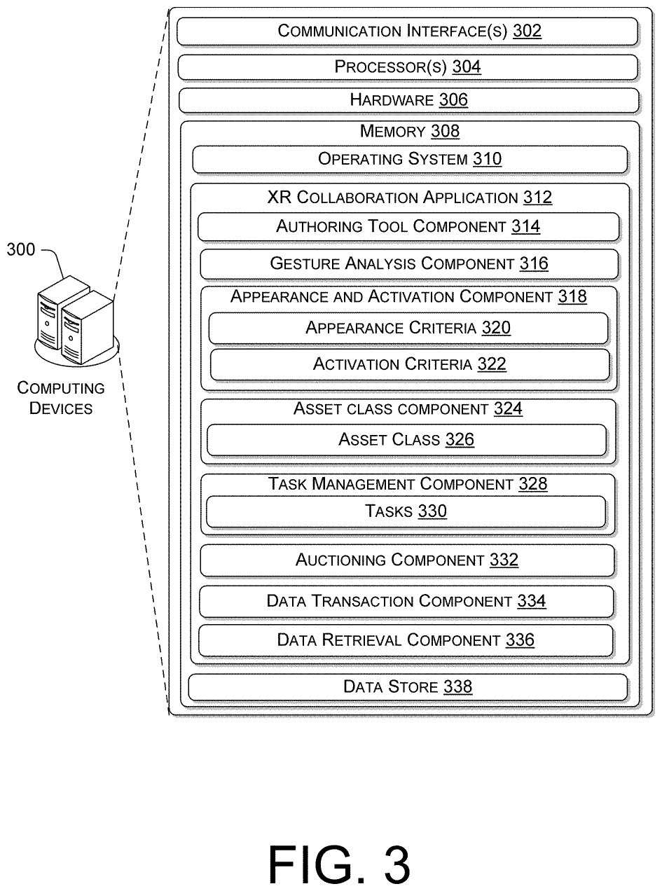

FIG. 3 is a block diagram showing various components of illustrative computing devices depicted in FIG. 1. It is noted that the computing devices 300 as described herein can operate with more or fewer of the components shown herein. Additionally, the computing devices 300 as shown herein or portions thereof can serve as a representation of one or more of the computing devices of the present system.

The computing devices 300 may include a communication interface 302, one or more processors 304, hardware 306, and memory 308. The communication interface 302 may include wireless and/or wired communication components that enable computing devices 300 to transmit data to and receive data from other networked devices. In at least one example, the one or more processor(s) 304 may be a central processing unit(s) (CPU), graphics processing unit(s) (GPU), both a CPU and GPU, or any other sort of processing unit(s). Each of the one or more processor(s) 304 may have numerous arithmetic logic units (ALUs) that perform arithmetic and logical operations as well as one or more control units (CUs) that extract instructions and stored content from processor cache memory, and then execute these instructions by calling on the ALUs, as necessary during program execution.

The one or more processor(s) 304 may also be responsible for executing all computer applications stored in the memory, which can be associated with common types of volatile (RAM) and/or nonvolatile (ROM) memory. The hardware 306 may include additional user interface, data communication, or data storage hardware. For example, the user interfaces may include a data output device (e.g., visual display, audio speakers), and one or more data input devices. The data input devices may include but are not limited to, combinations of one or more of keypads, keyboards, mouse devices, touch screens that accept gestures, microphones, voice or speech recognition devices, and any other suitable devices.

The memory 308 may be implemented using computer-readable media, such as computer storage media. Computer-readable media includes, at least, two types of computer-readable media, namely computer storage media and communications media. Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms. The memory 308 may also include a firewall. In some embodiments, the firewall may be implemented as hardware 306 in the computing devices 300.

The processor(s) 304 and the memory 308 of the computing devices 300 may implement an operating system 310, an XR collaboration application 312, and a data store 338. The data store 338 can comprise a data management layer that includes software utilities for facilitating the acquisition, processing, storing, reporting, and analysis of data. In one example, the data store 338 may store XR templates, XR, or virtual content (e.g., markers), objects, and/or so forth. In various embodiments, the data store 338 can be configured with an application program interface (API) that can be called by an application or interface with an API of the application for providing data access.

The operating system 310 may include components that enable the computing devices 300 to receive and transmit data via various interfaces (e.g., user controls, communication interface, and/or memory input/output devices), as well as process data using the processor(s) 304 to generate output. The operating system 310 may include a presentation component that presents the output (e.g., display the data on an electronic display, store the data in memory, transmit the data to another electronic device, etc.). Additionally, the operating system 310 may include other components that perform various additional functions generally associated with an operating system.

The XR collaboration application 312 may include routines, program instructions, objects, and/or data structures that perform particular tasks or implement particular abstract data types. For example, the XR collaboration application 312 may include one or more instructions, which when executed by the one or more processors 304 direct the computing devices 300 to perform operations related to creating, editing, modifying, viewing, and retrieving virtual content. The XR collaboration application 312 comprises an authoring tool component 314, a gesture analysis component 316, an appearance and activation component 318, an asset class component 324, a task management component 328, and an auctioning component 332.

The authoring tool component 314 may include one or more instructions which, when executed by the one or more processors 304, direct the computing devices 300 to perform operations related to creating, editing, modifying, viewing, and retrieving virtual content. The authoring tool component 314 enables a user (i.e., an XR author) to create and place virtual content (e.g., textual and/or multimedia content) such as markers or other graphical indicia in an XR environment. The virtual content may be associated with a real-world item or an object in the XR environment. The authoring tool component 314 may also be used to change the behavior of the virtual content.

Additionally, one or more rules may be applied to enable the virtual content to appear in an XR environment. In one example, virtual content may always be visible in an XR environment or presented to a user appear in response to a gesture or a user input to activate the content. In another example, one or more pins may appear in an XR environment in a predetermined order in response to deciding that one or more prerequisite pins had been activated and the content has been presented or viewed.

The authoring tool component 314 may be configured to add, change, or remove markers, content, and behavior as desired by performing manipulations within an XR environment. In some aspects, a user may make a gesture to perform manipulations within an XR environment. The manipulations may be made from scratch or an existing template. The authoring tool component 314 may then record the changes, which may be stored locally at a user device's storage or in a data store.

The gesture analysis component 316 may include one or more instructions which, when executed by the one or more processors 304, direct the computing devices 300 to perform operations related to capturing and quantifying a gesture performed by a user via an XR environment-enabled user device. In some examples, the gesture analysis component 316 may compare a captured gesture against stored gestures within an XR template to determine whether the gesture in an indicator for revealing virtual content, forgoing a presentation of virtual content, or dismissing a marker. Moreover, the gesture analysis component 316 may also monitor the user's interaction within an XR environment. In some aspects, the gesture analysis component 316 may implement machine learning algorithms to analyze the user's actions and determine whether those actions are consistent with instructions annotated or recorded within corresponding virtual content.

The appearance and activation component 318 may include one or more instructions which, when executed by the one or more processors 304, direct the computing devices 300 to perform operations related to generating appearance criteria 320 that are associated with markers and activation criteria 322 that are associated with the virtual content of an XR template. Appearance criteria 320 may be configured to control when markers display within an XR environment. Appearance criteria 320 may cause a marker to become visible or remain visible based on the fulfillment of a predetermined condition. The predetermined condition may be set by the user and may be based on threshold environmental data, such as a threshold temperature, a threshold noise level, a threshold light intensity, a threshold moisture level, a threshold odor intensity, or any other pertinent data. Alternatively, or additionally, the predetermined condition may be based on the user being within a predetermined proximity of a physical object within the XR environment.

Activation criteria 322 may be configured to control when the virtual content associated with a marker is displayed within the XR environment. In some examples, the activation criteria 322 may comprise a gesture performed by an application user that is interacting with an XR template within the XR environment. Activation criteria 322 may be configured to reveal virtual content, forgo a presentation of virtual content, or dismiss a presentation of a marker. While activation criteria 322 may correspond to a gesture performed by the user, other types of activation criteria 322 are possible. For example, activation criteria 322 may be based on one or more of an audible command, time, temperature data, light intensity data, moisture data, noise data, weather data, odor data, or any other form of pertinent data deemed relevant by the user.

The asset class component 324 may include one or more instructions which, when executed by the one or more processors 304, direct the computing devices 300 to perform operations related to dynamically generating asset classes of virtual content, appearance criteria 320, and activation criteria 322 that relate to a common marker (i.e., a physical object) within an XR template. A common marker may correspond to instances of the same type of physical object or virtual object. An asset class 326 may include virtual content, appearance criteria 320 (i.e., markers), and activation criteria 322 (i.e., virtual content). By grouping virtual content and corresponding criteria that relate to the same type of physical or virtual object, the asset class component 324 can simplify the proliferation of virtual content with the XR environment.

Further, the asset class component 324 may generate a sub-asset class to account for variations in a type of physical object or virtual object within an XR environment. Thus, Physical Object B that differs slightly from Physical Object A may be presented by an asset class of Physical Object A and a sub-asset class that accounts for the differences between Physical Objects A and B.

A task management component 328 may include one or more instructions which, when executed by the one or more processors 304, direct the computing devices 300 to perform operations related to creating, managing, and tracking tasks 330. In this regard, the task management component 328 may receive, from a user device, a task, or a request to create a task that is to be performed within an XR environment. In one example, a task may include instructions to interact with one or more objects and/or virtual content within the XR environment. In another example, a task may include instructions to create, edit, modify, view, and/or retrieve virtual content. A task may also include prerequisites to perform the task. For instance, the prerequisites may specify system requirements, technical requirements, credential requirements, and/or so forth.

The tasks 330 may be assigned or delegated to one or more collaborators operating within the XR environment. In some aspects, the task management component 328 may route the individual tasks 330 to the respective collaborators. If a task is unassigned or rejected by a collaborator, the task management component 328 may automatically reassign the task or place the task in the task queue. Additionally, the task management component 328 may track the status of the individual tasks 330 throughout its lifetime. The status of the tasks 330 may indicate whether a task is created, cancelled, assigned, delegated, in-queue, in-progress, completed, verified, and/or so forth. The task management component 328 may query the user devices associated with one or more collaborators to determine the status of a task. In some aspects, the task management component 328 may transmit a query on a scheduled basis to acquire and update the task status. Additionally, the task management component 328 may provide the task status to the creator of the task. The task status may be presented via a GUI of the XR collaboration application 312.

In some aspects, the tasks 330 may be time-sensitive. In this regard, a task may be associated with a deadline or a due date, and the task may expire upon reaching the deadline or the due date. In such a scenario, the task management component 328 may implement a countdown clock to calculate the amount of time left to complete a task-based at least on the time and date the task is created and the designated deadline or due date. If the task is not completed by the designated deadline or due date, the task management component 328 may alert the creator of the task. In some embodiments, the task management component 328 may query the creator of the task to renew the task or extend the deadline to provide more time to complete the task.

An auctioning component 332 may include one or more instructions, which when executed by the one or more processors 304 direct the computing devices 300 to perform operations related to requesting and receiving bids from one or more collaborators to perform a task. The auctioning component 332 may target a predetermined group of collaborators to request a bid based at least on one or more prerequisites associated with the task. For example, the auctioning component 332 may request bids from collaborators that are in an XR author's contact list. Additionally, or alternatively, the auctioning component 332 may allow bids from the public such that the bids are not limited to those from an XR author's contact list. In some aspects, the auctioning component 332 may implement a third-party platform on an auction-based marketplace to facilitate the bidding process.

The auctioning component 332 may receive bids for a predetermined period of time before the call for bids closes. Upon receiving the bids, the auctioning component 332 may automatically identify a winning bid based on one or more criteria and announce the winning bid to the XR author. The one or more criteria may include a price range, estimated time to completion of the task, credentials associated with the bidding collaborator, and/or so forth. In some aspects, the auctioning component 332 may notify the XR author that the bidding has closed and request the XR author to select a winning bid. Upon selecting a winning bid, the auctioning component 332 may instruct the task management component 328 to route the task to the bidding collaborator of the winning bid and track the task.

The data transaction component 334 may include one or more instructions, which when executed by the one or more processors 304 direct the computing devices 300 to perform operations related to receiving data transaction information of a data transaction from the data retrieval component 336. A data transaction is a transaction that affects the data associated with one or more tasks and/or one or more collaborators operating in an XR environment. In turn, the data transaction component 334 may use blockchain technology to generate a data transaction record for the data transaction information of each data transaction and store the record in a data transaction blockchain ledger such as the distributed ledger 120 of FIG. 1. The data transaction record may store the data transaction information as metadata in a body of the record. In various embodiments, the metadata may include other information, such as a transaction identifier, the date and time of the data transaction information receipt, a data transaction record identifier, and/or so forth. The metadata is encrypted by the data transaction component 334 using a unique encryption key. If the data transaction record is a first data transaction record to be added to the data transaction blockchain ledger 138, the data transaction component 334 may store an initial (e.g., random) signature value in the body of data transaction record. However, if the data transaction record is any subsequent data transaction record, the data transaction component 334 may store a unique cryptographic hash signature of a prior data transaction record of the data transaction blockchain ledger 138 in the body of the subsequent data transaction record. Subsequently, the data transaction component 334 may direct a cryptographic hash signature to be generated for the subsequent data transaction record using a hashing algorithm. The subsequent data transaction record is then added to the data transaction blockchain ledger 138. In this way, the cryptographic hash signature of each prior data transaction record in the ledger may be appended to a corresponding subsequent data transaction record in the ledger to create a series of linked data transaction records.

### Example Processes

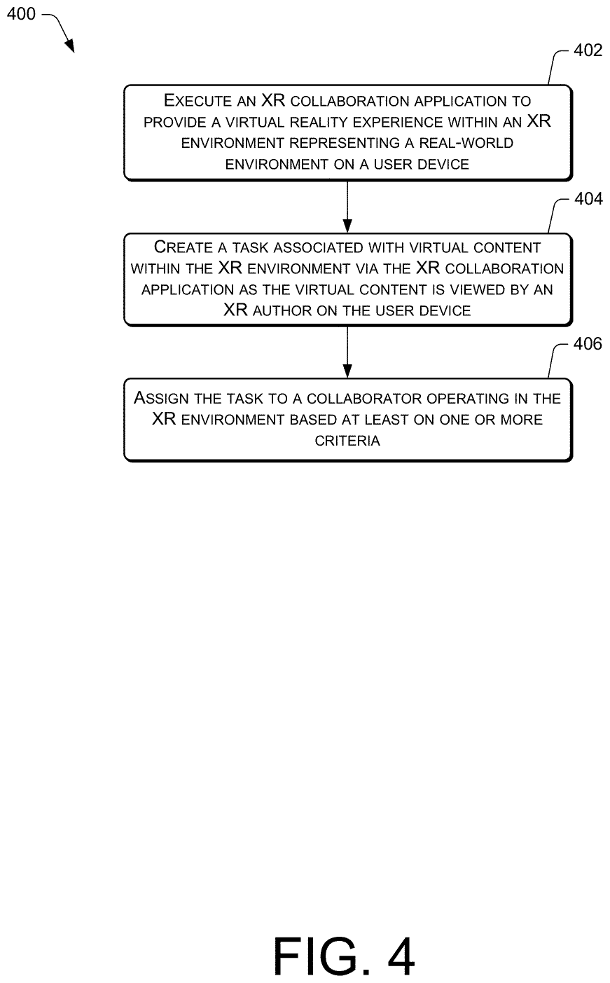

FIGS. 4-6 present illustrative processes 400-600 for providing a collaborative working space in an XR environment for multiple users. The processes 400-600 are illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 400-600 are described with reference to FIGS. 1-3.

FIG. 4 is a flow diagram of an example process for providing an ad hoc or planned collaborative working space in an XR environment for multiple users. At block 402, a user device may execute an XR collaboration application to provide a virtual reality experience within an XR environment representing a real-world environment on a user device. The XR collaboration application may include features such as an authoring tool and allow one or more users to interact with objects, virtual content, and/or other users in the XR environment. At block 404, an XR author may create a task that is associated with virtual content within the XR environment via the XR collaboration application as the virtual content is viewed by an XR author on the user device. The task may include instructions to create, edit, modify, view, and/or retrieve virtual content. At block 406, the XR author, via the user device, may assign the task to a collaborator operating in the XR environment based at least on one or more criteria. The one or more criteria can include a physical location of the collaborator, a qualification requirement associated with the task, and a certification of the collaborator. These individual criteria may correspond to a tag that may be associated with one or more collaborators. In some aspects, the collaborator may be selected from a contact list of the XR author, wherein the contact list may reside at least partially in the user device.

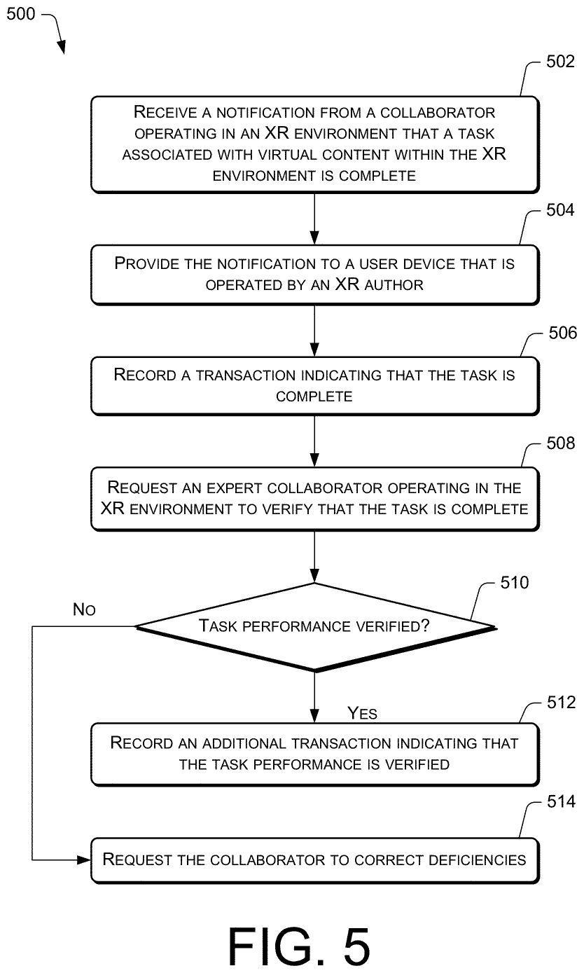

FIG. 5 is a flow diagram of an example process for verifying completion of a task. At block 502, a task management component of an XR collaboration application may receive a notification from a collaborator operating in an XR environment that a task associated with virtual content within the XR environment is complete. At block 504, the task management component may provide the notification of task completion to a user device that is operated by an XR author. The XR author may be the creator of the task. At block 506, the task management component may record a transaction indicating that the task is complete. The transaction may be referenced in a public ledger such as a blockchain. At block 508, the task management component may request an expert collaborator operating in the XR environment to verify that the task is complete. The expert collaborator may be associated with a user profile that includes a tag indicating the expert collaborator's credentials.

At decision block 510, the task management component may determine whether the task performance is verified. In response to determining that the task performance is verified (“yes” at block 510), the task management component may record an additional transaction indicating that the task performance is verified as indicated in block 512. The additional transaction may also be referenced in the blockchain. In response to determining that the task performance is not verified (“no” at block 510), the task management component may request the collaborator to correct deficiencies at block 514. In some aspects, the request may identify the deficiencies to be corrected.

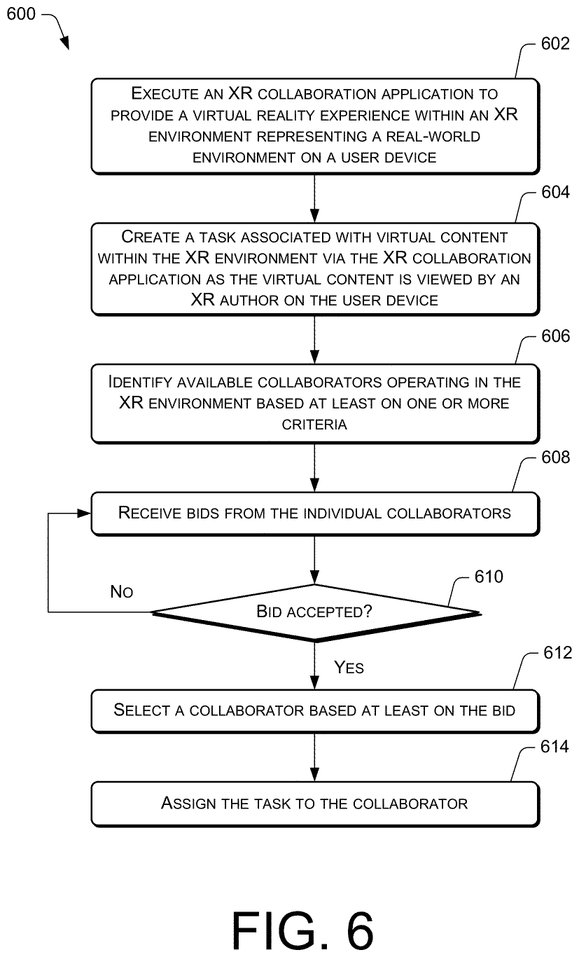

FIG. 6 is a flow diagram of an example process for selecting a collaborator to assign tasks. At block 602, a user device may execute an XR collaboration application to provide a virtual reality experience within an XR environment representing a real-world environment. At block 604, an XR author may create a task associated with virtual content within the XR environment via the XR collaboration application as the virtual content is viewed by an XR author on the user device. At block 606, the user device may identify available collaborators operating in the XR environment based at least on one or more criteria. The collaborators may be ad hoc collaborators or collaborators from the XR author's contact list. The contact list may be limited to vetted collaborators. At block 608, the user device may receive bids from the individual collaborators. In some aspects, the XR collaboration application may implement an auction-based marketplace to receive bids from the individual collaborators.

At decision block 610, the user device may determine whether a bid is accepted. The user device may make this determination based at least on one or more criteria as set by the XR author. Upon accepting a bid (“yes” at block 610), the user device may select a collaborator based at least on the bid as indicated in block 612. Additionally, or alternatively, the user device may provide a recommendation to accept an optimal bid or request the XR author to select a winning bid. If the bid is not accepted, the process goes back to block 608 and the user device may continue receiving bids from the individual collaborators. At block 612, the user device may assign the task to the collaborator that is associated with the winning bid.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that upon execution cause one or more processors to perform acts comprising:
executing an XR collaboration application to provide a virtual reality experience within an XR environment representing a real-world environment on a user device;
creating a task associated with virtual content within the XR environment via the XR collaboration application as the virtual content is viewed by an XR author on the user device; and
assigning the task to a collaborator operating in the XR environment based at least on one or more criteria.

2. The one or more non-transitory computer-readable media of claim 1, wherein the acts further comprise:
receiving a notification from the collaborator that the task is complete;
providing the notification on the user device; and
recording that the task is complete.

3. The one or more non-transitory computer-readable media of claim 2, wherein the acts further comprise:
transmitting a request to an expert collaborator operating in the XR environment to verify that the task is complete; and
in response to verifying that the task is complete, recording a verification associated with the task.

4. The one or more non-transitory computer-readable media of claim 1, wherein the acts further comprise:
recording a transaction that is associated with the task, the task referenced as a transaction in a distributed ledger comprising at least one blockchain.

5. The one or more non-transitory computer-readable media of claim 1, wherein the one or more criteria comprises at least one of a physical location of the collaborator, a qualification requirement associated with the task, and a certification of the collaborator.

6. The one or more non-transitory computer-readable media of claim 1, wherein the acts further comprise:
selecting the collaborator from a plurality of collaborators in a contact list associated with the user device.

7. The one or more non-transitory computer-readable media of claim 1, wherein the transaction includes credentials in accordance with a public key infrastructure (PKI)-based authentication protocol.

8. The one or more non-transitory computer-readable media of claim 1, wherein the acts further comprise:
routing the task to a task queue; and
scheduling the task-based at least on scheduling criteria.

9. A computer-implemented method, comprising:
executing an XR collaboration application to provide a virtual reality experience within an XR environment representing a real-world environment on a user device;
creating a task associated with virtual content within the XR environment via the XR collaboration application as the virtual content is viewed by an XR author on the user device; and
assigning the task to a collaborator operating in the XR environment based at least on one or more criteria.

10. The computer-implemented method of claim 9, further comprising:
receiving a notification from the collaborator that the task is complete;
providing the notification on the user device; and
recording that the task is complete.

11. The computer-implemented method of claim 9, further comprising:
transmitting a request to an expert collaborator operating in the XR environment to verify that the task is complete; and
in response to verifying that the task is complete, recording a verification associated with the task, the verification referenced as a transaction in a distributed ledger comprising at least one blockchain.

12. The computer-implemented method of claim 9, wherein the virtual content is associated with an appearance criterion and the activation criterion, the virtual content, the appearance criterion, and the activation criteria grouped into an asset class, and further comprising:
assigning the task to the collaborator based at least on the asset class.

13. The computer-implemented method of claim 9, further comprising:
selecting the collaborator from a plurality of collaborators in a contact list associated with the user device.

14. The computer-implemented method of claim 9, wherein the transaction utilizes a multifactor authentication.

15. The computer-implemented method of claim 9, further comprising:
requesting a bid from one or more collaborators to complete the task; and
selecting the collaborator from the one or more collaborators based at least on the bid.

16. A system, comprising:
one or more non-transitory storage mediums configured to provide stored computer-readable instructions, the one or more non-transitory storage mediums coupled to one or more processors, the one or more processors configured to execute the computer-readable instructions to cause the one or more processors to:
execute an XR collaboration application to provide a virtual reality experience within an XR environment representing a real-world environment on a user device;
create a task associated with virtual content within the XR environment via the XR collaboration application as the virtual content is viewed by an XR author on the user device; and
assign the task to a collaborator operating in the XR environment based at least on one or more criteria.

17. The system of claim 16, wherein the virtual content is associated with a marker for an object depicted in the XR environment, and wherein the one or more processor is further configured to:
identify an object type corresponding to the object; and
assign the task to the collaborator based at least on the object type.

18. The system of claim 16, wherein the one or more processors is further configured to:
receive a notification that the task is complete;
in response to receiving the notification, transmit a request to an expert collaborator operating in the XR environment to verify that the task is complete; and
in response to verifying that the task is complete, record a verification associated with the task; and
record that the task is complete.

19. The system of claim 16, wherein the one or more processors is further configured to:
record a transaction that is associated with the task, the task referenced as a transaction in a distributed ledger comprising at least one blockchain; and
in response to determining that the task is complete, update the distributed ledger.

20. The system of claim 19, wherein the one or more processors is further configured to:
record a verification indicating that the task is complete, the verification referenced as an additional transaction in the distributed ledger comprising the at least one blockchain.
